(19) United States
(12) Patent Application Publication
(10) Pub. No.: US 2026/0109582 A1
(43) Pub. Date: Apr. 23, 2026

(54) LIFTING APPARATUS

(71) Applicants: HYUNDAI MOTOR COMPANY, SEOUL (KR); KIA CORPORATION, SEOUL (KR)

(72) Inventors: Geon Beom Lee, Hwaseong-si (KR); Yu Seung Shin, Hwaseong-si (KR); Byung Ho Yoon, Hwaseong-si (KR); Hyun Sik Sim, Hwaseong-si (KR)

(73) Assignees: HYUNDAI MOTOR COMPANY, SEOUL (KR); KIA CORPORATION, SEOUL (KR)

(21) Appl. No.: 19/228,736

(22) Filed: Jun. 4, 2025

(30) Foreign Application Priority Data
Oct. 21, 2024 (KR) 10-2024-0144385

(51) Int. Cl. B66F 7/14

(52) U.S. Cl. CPC B66F 7/14

(57) ABSTRACT

The present disclosure relates to a lifting apparatus including a slider that slides in a first direction, a lifting part elevated in a second direction intersecting the first direction by the slider, and a guide bracket coupled to the lifting part on one side of the lifting part toward the slider and interfering with the slider to elevate the lifting part in the second direction.

### CROSS REFERENCE TO RELATED APPLICATIONS

This application claims the benefit of priority to Korean Patent Application No. 10-2024-0144385, filed in the Korean Intellectual Property Office on Oct. 21, 2024, the entire contents of which are incorporated herein by reference.

### TECHNICAL FIELD

The present disclosure relates to a lifting apparatus.

### BACKGROUND

A lifting apparatus may be an apparatus that raises a separate object upward or lowers the separate object downward. The lifting apparatus may include a lifting plate that supports the separate object.

In general, the lifting apparatus may require a link structure or a separate elevating device that is operated while being connected to the lifting plate to elevate the lifting plate. According to the link structure or the elevating device, it is necessary to continuously apply a driving force to fix a height of the lifting plate after the lifting plate is completely lifted or the lifting plate is completely lowered.

According to this structure, because a consumption speed of a driving source may be increased, the need for the lifting apparatus capable of reducing the consumption of the driving source is increasing.

### SUMMARY

The present disclosure has been made to solve the above-mentioned problems occurring in the prior art while advantages achieved by the prior art are maintained intact.

An aspect of the present disclosure provides a lifting apparatus capable of reducing consumption of a driving source.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a lifting apparatus includes a slider that slides in a first direction, a lifting part elevated in a second direction intersecting the first direction by the slider, and a guide bracket coupled to the lifting part on one side of the lifting part toward the slider and interfering with the slider to elevate the lifting part in the second direction.

The guide bracket may include a guide surface extending in a direction intersecting the first direction and the second direction on a plane formed parallel to the first direction and the second direction.

The guide bracket may include a first seating surface provided on one side of the guide surface in the first direction and extending parallel in the second direction and a second seating surface provided on the other side of the guide surface in the first direction and extending parallel in the second direction.

The slider may include a slider frame that slides in the first direction and a slider roller rotatably mounted on the slider frame and formed to roll along the guide surface.

The lifting apparatus according to an embodiment of the present disclosure may further include a housing that includes a base plate and surrounds the slider and the guide bracket and a guide rail supported by the base plate and extending in the first direction to guide sliding of the slider frame.

The slider may further include a sliding guider fixed to the slider frame and having a guide protrusion protruding toward the guide rail, and the guide rail may include a rail groove into which the guide protrusion is inserted.

The lifting apparatus according to the embodiment of the present disclosure may further include a driving part that slides the slider and includes a driving motor and a guide shaft rotated by the driving motor, and the slider may further include a slider coupling part connected to the slider frame and sliding in the first direction by the rotation of the guide shaft.

The guide shaft may be formed as a ball screw, and the slider coupling part may include a ball nut engaged with the guide shaft.

The lifting part may include a lifting plate to which the guide bracket is coupled and which faces one side of the second direction and a lifting column extending from the lifting plate in the second direction to support the lifting plate.

The lifting part may further include a guide supporter inserted into the lifting column and extending in the second direction, and the lifting column may include a lifting groove into which the guide supporter is inserted and which extends in the second direction.

The lifting part may further include a seating pad protruding to the one side of the lifting plate in the second direction and made of an elastic material.

The lifting plate may include a plate area extending in the first direction and a third direction intersecting the first direction and the second direction and a protrusion area protruding from the plate area toward the guide bracket and extending in the first direction, and the guide bracket may include a seating wall on which the protrusion area is seated and a support wall that forms a seating groove into which the protrusion area is inserted together with the seating wall and support the protrusion area.

The guide bracket may be provided as a pair of guide brackets in the first direction, and the guide surfaces thereof may be i) arranged parallel to each other or ii) arranged to face each other.

The base plate may include a guide rail groove on which the guide rail is seated.

The lifting apparatus according to the embodiment of the present disclosure may further include a housing that includes a base plate and surrounds the slider and the guide bracket, the driving part may include a shaft support body that supports the guide shaft, and the base plate may include a driving motor groove on which the driving motor is seated and a shaft support body groove on which the shaft support body is seated.

According to an aspect of the present disclosure, a lifting apparatus includes a slider that slides in a first direction, a lifting part elevated in a second direction intersecting the first direction by the slider, and a guide bracket coupled to the lifting part on one side of the lifting part toward the slider and interfering with the slider to elevate the lifting part in the second direction. The guide bracket includes a surface intersecting the first direction and the second direction on a plane formed parallel to the first direction and the second direction.

### BRIEF DESCRIPTION OF THE FIGURES

The above and other objects, features and advantages of the present disclosure will be more apparent from the following detailed description taken in conjunction with the accompanying drawings:

FIG. 1 is a perspective view of a lifting apparatus according to an embodiment of the present disclosure;

FIG. 2 is an exploded perspective view of a lifting apparatus according to the embodiment of the present disclosure;

FIG. 3 is a perspective view of a driving part, a slider, and a guide rail mounted on a housing according to the embodiment of the present disclosure;

FIG. 4 is a perspective view of a lifting part and a guide bracket according to the embodiment of the present disclosure;

FIG. 5 is a perspective view of the lifting part and the guide bracket of FIG. 4 according to the embodiment of the present disclosure;

FIG. 6 is an enlarged view of a bottom surface of the lifting part of FIG. 4 according to the embodiment of the present disclosure;

FIG. 7 is an enlarged view of the lifting part of FIG. 4 and the guide bracket according to the embodiment of the present disclosure;

FIG. 8 is a side view of the lifting part of FIG. 4, the driving part, the slider, the guide bracket, and the guide rail when the lifting part is disposed at a first position according to the embodiment of the present disclosure;

FIG. 9 is a side view of the lifting part of FIG. 4, the driving part, the slider, the guide bracket, and the guide rail when the lifting part is disposed at a second position according to the embodiment of the present disclosure;

FIG. 10 is a side view of the lifting part of FIG. 4, the driving part, the slider, the guide bracket, and the guide rail when the lifting part is disposed at a third position according to the embodiment of the present disclosure;

FIG. 11 is a perspective view of the lifting part of FIG. 4, the driving part, the slider, the guide bracket, and the guide rail when the lifting part is disposed at the third position according to the embodiment of the present disclosure;

FIG. 12 is an enlarged view of the guide rail and a sliding guider illustrated in FIG. 11;

FIG. 13 is a perspective view of the lifting part of FIG. 4, the driving part, the slider, the guide bracket, and the guide rail when the lifting part is disposed at the second position according to the embodiment of the present disclosure;

FIG. 14 is a perspective view of the lifting part of FIG. 4, the driving part, the slider, the guide bracket, and the guide rail when the lifting part is disposed at the first position according to the embodiment of the present disclosure;

FIG. 15 is a side view of the lifting part of FIG. 4, the driving part, the slider, the guide bracket, and the guide rail according to another embodiment of the present disclosure;

FIG. 16 is a perspective view of a lifting part of FIG. 4 and a guide bracket according to still another embodiment of the present disclosure; and

FIG. 17 is a perspective view of a lifting part and a guide bracket according to yet another embodiment of the present disclosure.

### DETAILED DESCRIPTION

Hereinafter, some embodiments of the present disclosure will be described in detail with reference to the exemplary drawings. In adding reference numerals to components of each drawing, it should be noted that identical or equivalent components are designated by an identical numeral even when they are displayed on other drawings. Further, in describing the embodiment of the present disclosure, a detailed description of the related known configuration or function will be omitted when it is determined that the detailed description interferes with the understanding of the embodiment of the present disclosure.

Further, in describing the components of the embodiments of the present disclosure, terms, such as first, second, “A”, “B”, (a), and (b) may be used. These terms are merely intended to distinguish one component from other components, and the terms do not limit the nature, order, or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

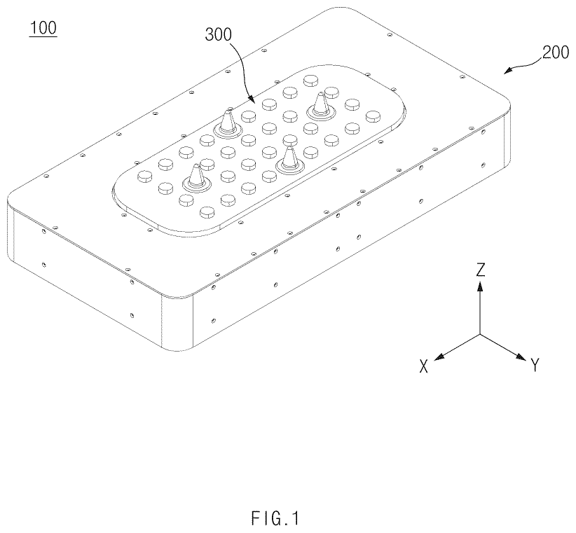

Hereinafter, embodiments of the present disclosure will be described in detail with reference to FIGS. 1 to 17. Hereinafter, one side (X direction) of a first direction may be a forward side, and the other side (opposite to the X direction) of the first direction may be a rearward side. One side (Z direction) of a second direction may be an upward side, and the other side (opposite to a Z direction) of the second direction may be a downward side. Further, the first direction, the second direction and a third direction may be perpendicular to each other.

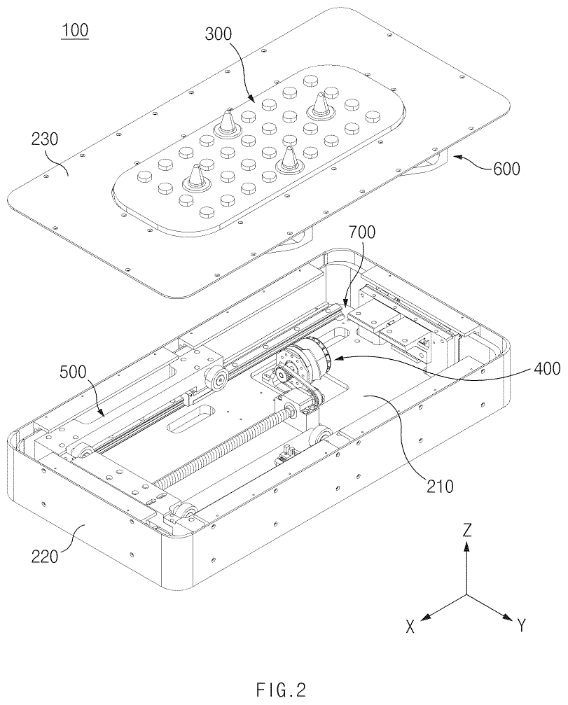

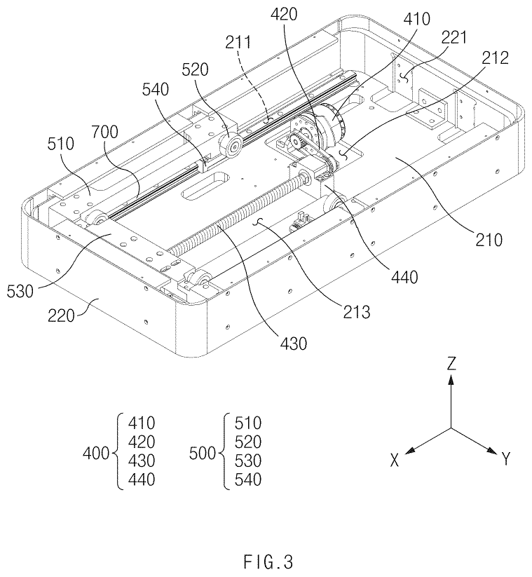

FIG. 1 is a perspective view of a lifting apparatus according to an embodiment of the present disclosure. FIG. 2 is an exploded perspective view of a lifting apparatus according to the embodiment of the present disclosure. FIG. 3 is a perspective view of a driving part, a slider, and a guide rail mounted on a housing according to the embodiment of the present disclosure.

Referring to FIGS. 1 to 3, a lifting apparatus 100 may be an apparatus for elevating a separate object while supporting the object, which is not separately illustrated in the drawings.

The lifting apparatus 100 may include a housing 200, a lifting part 300 that supports the object, a driving part 400 mounted inside the housing 200, and a slider 500 provided to slide in the first direction (e.g., the X direction or an opposite direction to the X direction) inside the housing 200.

The lifting apparatus 100 may further include a guide bracket 600 that interferes with the slider 500 and is coupled to the lifting part 300 and a guide rail 700 that guides the sliding of the slider 500 in the first direction.

The housing 200 may include a base plate 210, a side wall 220 extending along a circumference of the base plate 210 and coupled to the base plate 210, and a top plate 230. The housing 200 may be provided to surround the driving part 400, the slider 500, and the guide bracket 600.

The lifting part 300 may be provided to be elevated in the second direction (the Z direction or an opposite direction to the Z direction) perpendicular to the first direction by the slider 500. The lifting part 300 may be coupled to the guide bracket 600 and may be elevated in the second direction as the guide bracket 600 interferes with the slider 500. The lifting part 300 may include a lifting plate 310 that supports an object.

The driving part 400 may be provided to slide the slider 500 by supplying a driving force of the lifting apparatus 100. The driving part 400 may include a battery (not illustrated), a driving motor 410, a connection belt 420, a guide shaft 430, and a shaft support body 440.

The driving motor 410 may be driven by the battery. The connection belt 420 may be configured to connect the driving motor 410 and the guide shaft 430 and transmit a rotational force so that the guide shaft 430 rotates. The driving motor 410 may be fixed to the base plate 210.

The guide shaft 430 may be rotated by the driving motor 410. The guide shaft 430 may be rotated by receiving a force of the driving motor 410 by the connection belt 420. The guide shaft 430 may have a threaded surface and be formed as a ball screw. Both ends of the guide shaft 430 in the first direction may be rotatably supported by the shaft support body 440.

The shaft support body 440 may support the guide shaft 430. The shaft support body 440 may be coupled to the base plate 210 to support both ends of the guide shaft 430 in the first direction.

The slider 500 may include a slider frame 510 provided to slide in the first direction along the guide rail 700 and a slider roller 520 rotatably mounted on the slider frame 510.

The slider 500 may further include a slider coupling part 530 engaged with the guide shaft 430 and a sliding guider 540 coupled to the slider frame 510 and in contact with the guide rail 700.

Both the slider frame 510 and the guide rail 700 may extend in the first direction. The slider frame 510 may be provided as a pair of slider frames 510, the guide rail 700 may be provided as a pair of guide rails 700, and the slider frames 510 may slide in the first direction along the guide rails 700, respectively.

The slider coupling part 530 may be provided between the slider frames 510 and extend in the third direction (the Y direction and an opposite direction to the Y direction) perpendicular to the first direction and the second direction. The slider coupling part 530 may be connected to or coupled to the pair of slider frames 510.

The slider coupling part 530 may be moved in the first direction by rotation of the guide shaft 430. The slider coupling part 530 may include a ball nut (not illustrated) engaged with the guide shaft 430.

The slider coupling part 530 may move in the first direction according to the rotation of the guide shaft 430, and the slider frame 510 may slide in the first direction along the slider coupling part 530.

The sliding guider 540 may be coupled to the slider frame 510 and disposed between the slider frame 510 and the guide rail 700. The sliding guider 540 may guide the sliding of the slider frame 510 so that the slider frame 510 may smoothly slide along the guide rail 700.

The guide bracket 600 may be coupled to the lifting part 300 at one side of the lifting part 300 toward the slider 500 and may be provided to lift or lower the lifting part 300 in the second direction while interfering with the slider 500.

The guide rail 700 may be supported by the base plate 210. The guide rail 700 may extend in the first direction to guide the sliding of the sliding guider 540 and the slider frame 510. The guide rail 700 may be coupled to the base plate 210.

Meanwhile, the base plate 210 may include a guide rail groove 211, a driving motor groove 212, and a shaft support body groove 213. The guide rail groove 211, the driving motor groove 212, and the shaft support body groove 213 may be formed to be open toward one side (Z direction) of the second direction.

The guide rail 700 may be seated on the guide rail groove 211. The driving motor 410 may be mounted on the driving motor groove 212. The shaft support body 440 may be seated on the shaft support body groove 213.

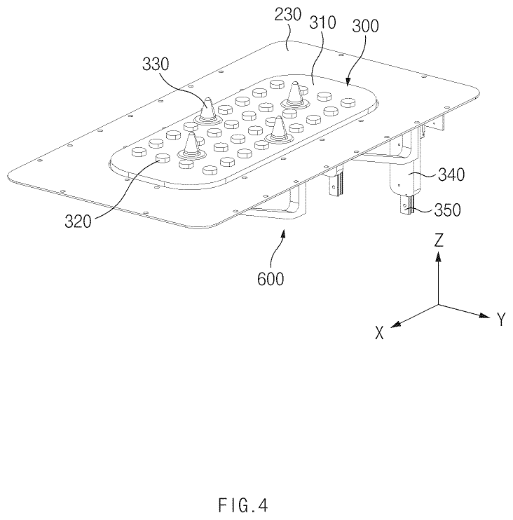

Further, a supporter groove 221 extending in the second direction may be formed in the side wall 220. The supporter groove 221 may be formed on one surface of the side wall 220 toward an inside of the housing 200. A guide supporter 350 (see FIG. 4), which will be described below, may be mounted on the supporter groove 221.

According to this structure, because installation locations of the guide supporter 350, the driving motor 410, the shaft support body 440, and the guide rail 700 are guided inside the housing 200, manufacturability of the lifting apparatus 100 may be improved.

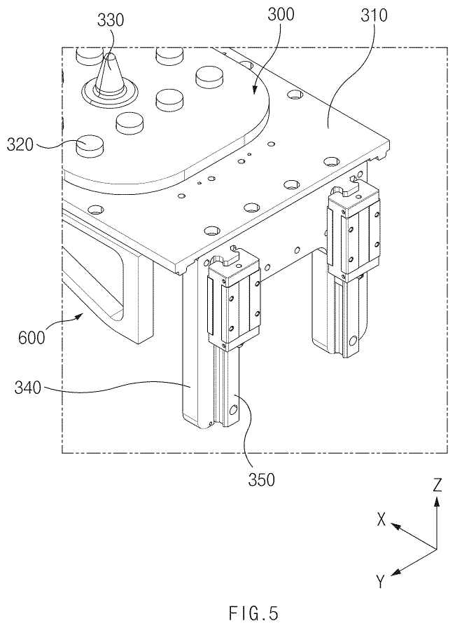

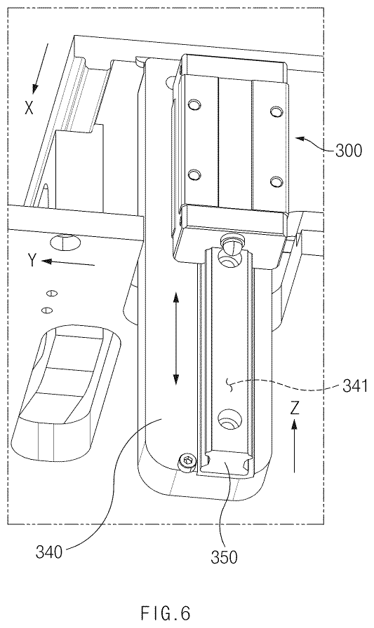

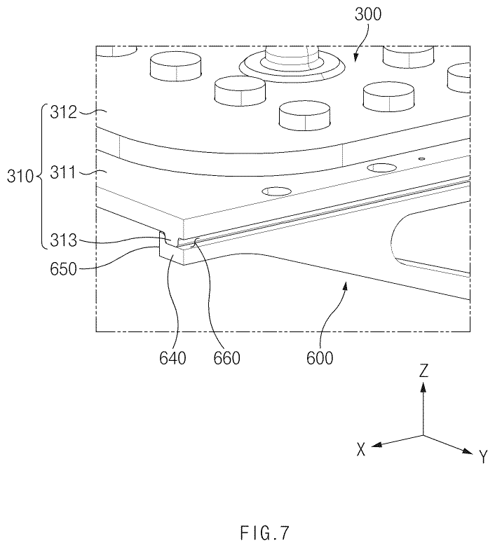

FIG. 4 is a perspective view of a lifting part and a guide bracket according to the embodiment of the present disclosure. FIG. 5 is a perspective view of the lifting part and the guide bracket according to the embodiment of the present disclosure. FIG. 6 is an enlarged view of a bottom surface of the lifting part according to the embodiment of the present disclosure. FIG. 7 is an enlarged view of the lifting part and the guide bracket according to the embodiment of the present disclosure.

Referring to FIGS. 4 to 7, the lifting part 300 may include the lifting plate 310, a seating pad 320, a fixing protrusion 330, a lifting column 340, and the guide supporter 350.

The lifting plate 310 may be coupled to the guide bracket 600 and may face one side (Z direction) in the second direction. When viewed from a state spaced apart from one side of the second direction, the lifting plate 310 may be formed in an approximately rectangular shape. The guide bracket 600 may be coupled to both circumferential areas of the lifting plate 310 in the third direction.

The seating pad 320 and the fixing protrusion 330 may be provided at one side of the lifting plate 310 in the second direction. The seating pad 320 may protrude to one side of the lifting plate 310 in the second direction and may be formed of an elastic member. The seating pad 320 may be configured to apply friction to a surface of the object to prevent the object from sliding from the lifting plate 310.

The fixing protrusion 330 may be a conical protrusion protruding from the lifting plate 310 toward the object. The fixing protrusion 330 may be a component inserted into the object to fix a position of the object.

The lifting column 340 may extend from the lifting plate 310 to the other side (opposite direction to the Z direction) of the second direction to support the lifting plate 310. The lifting column 340 may be coupled to the lifting plate 310. The lifting column 340 may move along the guide supporter 350 to guide lifting of the lifting plate 310.

In more detail, the guide supporter 350 may extend in the second direction and be inserted into the lifting column 340. The lifting column 340 may include a lifting groove 341 formed at one side facing the guide supporter 350. The lifting groove 341 may be a groove which extends in the second direction and into which the guide supporter 350 is inserted.

According to this structure, the lifting column 340 may more smoothly guide the movement of the lifting plate 310 in the second direction along the guide supporter 350.

Meanwhile, the lifting plate 310 may include a plate area 311, a pad support area 312, and a protrusion area 313. The plate area 311 may extend in the first direction and the third direction. The pad support area 312 may be an area which protrudes from the plate area 311 toward the one side of the second direction and in which the seating pad 320 is provided.

The protrusion area 313 may protrude from the plate area 311 toward the guide bracket 600. The protrusion area 313 may be a protrusion protruding from both sides of the plate area 311 in the third direction to the other side (opposite direction to the Z direction) of the second direction and extending in the first direction.

The guide bracket 600 may be coupled to both side areas of the lifting plate 310 in the third direction. The guide bracket 600 may include a seating wall 640 in which the protrusion area 313 is seated and a support wall 650 forming a seating groove 660 into which the protrusion area 313 is inserted together with the seating wall 640 and supporting the protrusion area 313.

The seating wall 640 and the support wall 650 may form the seating groove 660 together. The seating groove 660 may be formed to be open to the one side (Z direction) of the second direction and the one side (Y direction) of the third direction.

The seating wall 640 may be in contact with the protrusion area 313 on the other side (opposite direction to the Z direction) of the protrusion area 313 in the second direction. The support wall 650 may extend from the seating wall 640 to the one side of the second direction on the other side (opposite direction to the Y direction) of the protrusion area 313 in the third direction. The support wall 650 may be in contact with the protrusion area 313 on the other side of the protrusion area 313 in the third direction.

According to this structure, in a manufacturing process of coupling the guide bracket 600 to the lifting part 300, a position of the guide bracket 600 may be guided, and thus productivity of the lifting apparatus 100 (see FIG. 1) may be improved.

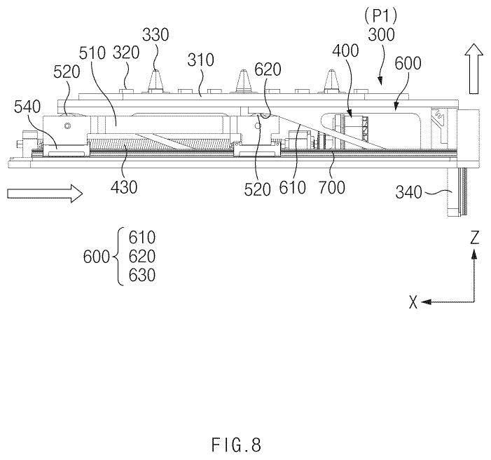

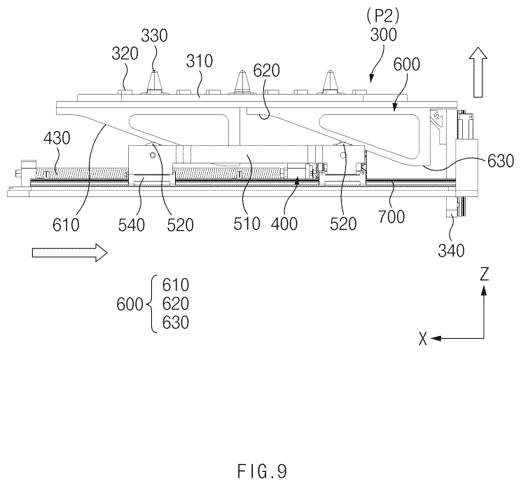

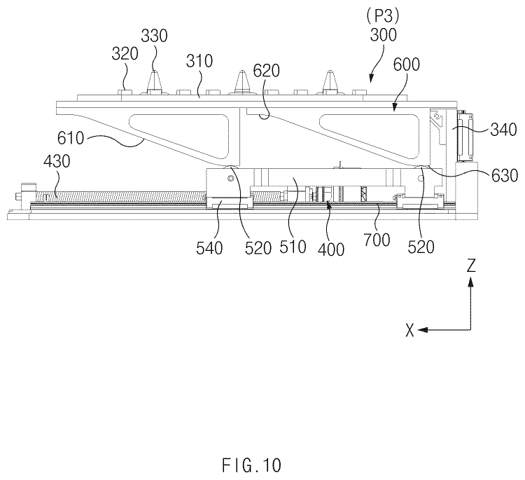

FIG. 8 is a side view of the lifting part, the driving part, the slider, the guide bracket, and the guide rail when the lifting part is disposed at a first position according to the embodiment of the present disclosure. FIG. 9 is a side view of the lifting part, the driving part, the slider, the guide bracket, and the guide rail when the lifting part is disposed at a second position according to the embodiment of the present disclosure. FIG. 10 is a side view of the lifting part, the driving part, the slider, the guide bracket, and the guide rail when the lifting part is disposed at a third position according to the embodiment of the present disclosure.

Referring to FIGS. 8 to 10, the lifting part 300 may be disposed at a first position P1, a second position P2, and a third position P3. In this case, the first position P1 of the lifting part 300 may be when the lifting part 300 is located at the lowest height, and the third position P3 of the lifting part 300 may be when the lifting part 300 is located at the highest height. The second position P2 of the lifting part 300 may be when the lifting part 300 is located at a height between the first position and the third position.

As the guide shaft 430 of the driving part 400 rotates, the slider coupling part 530 (see FIG. 3) may move from the one side (X direction) to the other side (opposite direction to the X direction) of the first direction. In this case, the slider frame 510 connected to the slider coupling part 530 may slide along the guide rail 700 toward the other side of the first direction by the sliding guider 540.

The slider roller 520 may be mounted on the slider frame 510, and the slider roller 520 may interfere with the guide bracket 600.

In more detail, the guide bracket 600 may include a guide surface 610 extending in a direction intersecting the first direction and the second direction on a plane formed in parallel to the first direction and the second direction. The guide surface 610 may extend toward the one side (X direction) of the first direction and the one side (Z direction) of the second direction.

The guide bracket 600 may include a first seating surface 620 provided on one side of the guide surface 610 in the first direction and extending in parallel in the second direction and a second seating surface 630 provided on the other side of the guide surface 610 in the first direction and extending in parallel in the second direction. The first seating surface 620 and the second seating surface 630 may be provided to be flat, and a position of the first seating surface 620 in the second direction may be disposed closer to the one side of the second direction than a position of the second seating surface 630 in the second direction. That is, the first seating surface 620 may be disposed higher than the second seating surface 630.

The slider roller 520 may be rotatably mounted on the slider frame 510 and may be formed to roll with respect to the first seating surface 620, the guide surface 610, and the second seating surface 630.

As illustrated in FIG. 8, when the slider frame 510 is located closest to one side in an operating range of the slider frame 510 in the first direction, the slider roller 520 may be in contact with the first seating surface 620.

As the slider frame 510 moves to the other side of the first direction, the slider roller 520 may roll along the first seating surface 620. In this case, the lifting part 300 may be disposed at the first position P1 that is the lowest position, and a height of the lifting part 300 may be fixed while the slider roller 520 rolls on the first seating surface 620.

Meanwhile, the slider rollers 520 may be provided on both sides of the pair of slider frames 510 in the first direction, but the present disclosure is not limited thereto. The guide bracket 600 may be provided in a number corresponding to the number of slider rollers 520 and coupled to the lifting plate 310. In this case, the guide brackets 600 may be arranged in parallel with each other.

As illustrated in FIG. 9, when the slider frame 510 continues to slide to the other side of the first direction, the slider roller 520 may roll along the guide surface 610.

The guide surface 610 may extend in the other side of the first direction and the other side (opposite direction to the Z direction) of the second direction. The guide surface 610 may be pressed to the one side of the second direction by the slider roller 520 as the slider roller 520 moves to the other side of the first direction. That is, the guide bracket 600 may be moved to the one side of the second direction by receiving a force from the one side of the second direction by the slider roller 520.

When the guide bracket 600 is moved to the one side of the second direction, the lifting part 300 may be disposed at the second position P2. In this case, the second position P2 may be a predetermined position between the first position P1 and the third position P3. According to the above-described principle, when the slider frame 510 is moved to the other side of the first direction, the lifting part 300 may be lifted or lowered.

As illustrated in FIG. 10, when the slider frame 510 continues to slide to the other side of the first direction, the slider roller 520 may roll on the second seating surface 630. When the slider frame 510 is located closest to the other side of the first direction in the operating range of the slider frame 510, the slider roller 520 may be in contact with the second seating surface 630.

In this case, the lifting part 300 may be disposed at the third position P3 which is the highest position, and the height of the lifting part 300 may be fixed while the slider roller 520 rolls on the second seating surface 630.

Thus, in a process of lifting the lifting part 300 from the first position P1 to the third position P3, the lifting apparatus 100 (see FIG. 1) may smoothly lift the lifting part 300 only with the driving motor 410 (see FIG. 3).

Further, when the lifting part 300 is disposed at the first position P1 and the third position P3, the height of the lifting part 300 may be fixed, even when a driving source of the driving part 400 is not supplied, and thus consumption of the driving source may be saved, and a usage time of the lifting apparatus 100 may be increased.

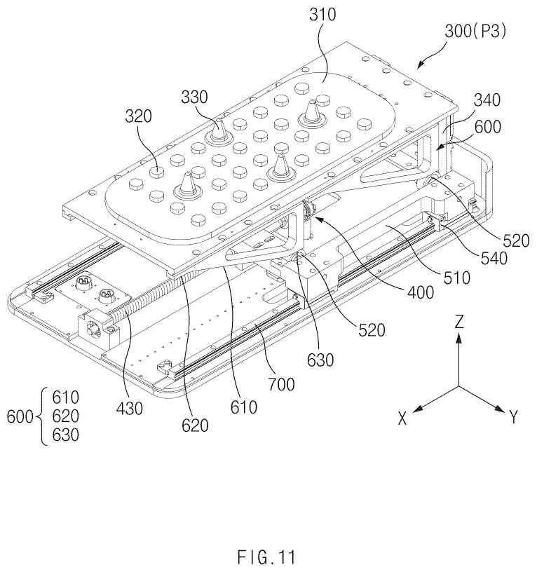

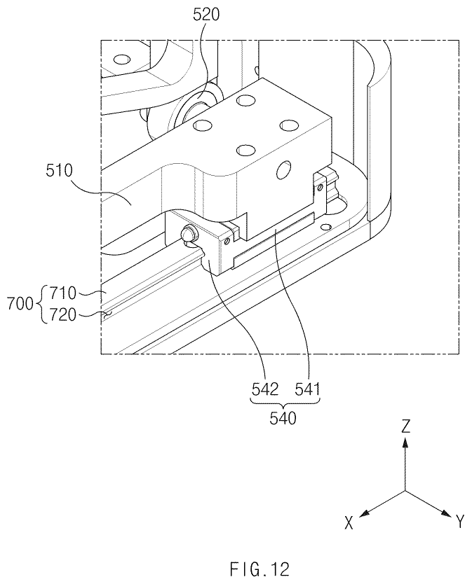

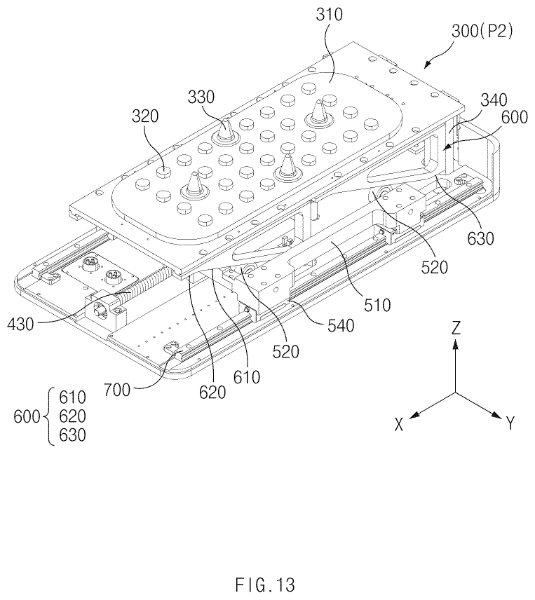

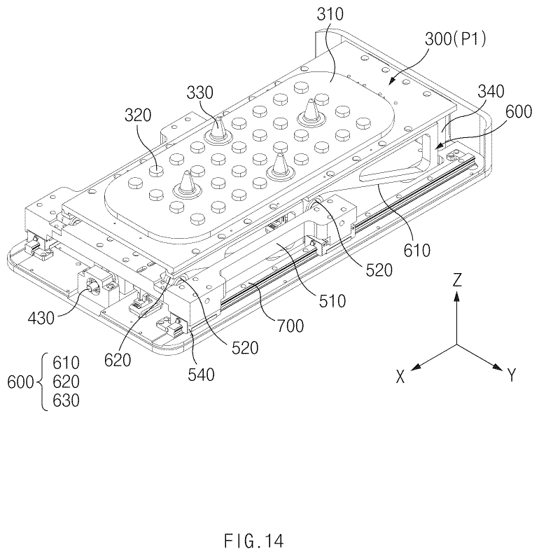

FIG. 11 is a perspective view of the lifting part, the driving part, the slider, the guide bracket, and the guide rail when the lifting part is disposed at the third position according to the embodiment of the present disclosure. FIG. 12 is an enlarged view of the guide rail and a sliding guider illustrated in FIG. 11. FIG. 13 is a perspective view of the lifting part, the driving part, the slider, the guide bracket, and the guide rail when the lifting part is disposed at the second position according to the embodiment of the present disclosure; FIG. 14 is a perspective view of the lifting part, the driving part, the slider, the guide bracket, and the guide rail when the lifting part is disposed at the first position according to the embodiment of the present disclosure.

Referring to FIGS. 11 to 14, as the slider frame 510 is moved to the one side (X direction) of the first direction, the lifting part 300 may be disposed at the third position P3, the second position P2, and the first position P1.

As illustrated in FIG. 11, when sliding starts toward the one side (X direction) of the slider frame 510 in the first direction from a point located closest to the other side of the first direction in the operating range of the slider frame 510, the slider roller 520 may roll along the second seating surface 630. In this case, the height of the lifting part 300 may not be changed at the third position P3.

As illustrated in FIG. 12, the sliding guider 540 may include a guider body 541 coupled to the slider frame 510 and a guide protrusion 542 protruding from the guider body 541 toward the guide rail 700 on opposite sides of the guide rail 700 in the third direction.

The guide rail 700 may include a guide rail body 710 extending in the first direction and in contact with the guider body 541 and a rail groove 720 formed to be open on both sides of the guide rail body 710 in the third direction. The rail groove 720 may be a space into which the guide protrusion 542 is inserted.

According to this structure, because the sliding guider 540 slides in the first direction while maintaining contact with the guide rail 700, the sliding guider 540 may smoothly slide in the first direction.

As illustrated in FIG. 13, when sliding is performed toward the one side (X direction) of the slider frame 510 in the first direction at an approximately middle position in the operating range of the slider frame 510, the slider roller 520 may roll along the guide surface 610.

Since the guide surface 610 extends to the one side of the first direction and the one side of the second direction, as the slider roller 520 rolls along the guide surface 610, the guide bracket 600 may be moved to the other side of the second direction. When the guide bracket 600 is moved to the other side of the second direction, the lifting part 300 may be lowered from the second position P2 disposed between the third position P3 and the first position P1 toward the first position P1.

As illustrated in FIG. 14, when sliding is further performed toward the one side (X direction) of the slider frame 510 in the first direction to a point located closest to the one side of the first direction in the operating range of the slider frame 510, the slider roller 520 may roll along the first seating surface 620. In this case, the height of the lifting part 300 may not be changed at the first position P1.

Thus, in a process of lowering the lifting part 300 from the third position P3 to the first position P1, the lifting apparatus 100 (see FIG. 1) may smoothly lift the lifting part 300 only with the driving motor 410 (see FIG. 3).

Further, when the lifting part 300 is disposed at the first position P1 and the third position P3, the height of the lifting part 300 may be fixed even when the driving source of the driving part 400 is not supplied, and thus consumption of the driving source may be saved, and a usage time of the lifting apparatus 100 may be increased.

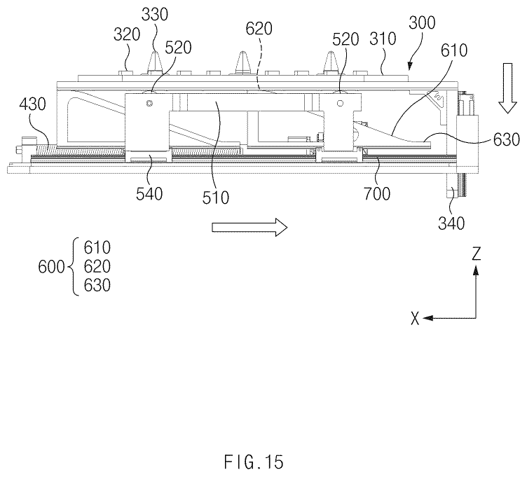

FIG. 15 is a side view of the lifting part, the driving part, the slider, the guide bracket, and the guide rail according to another embodiment of the present disclosure.

Referring to FIG. 15, unlike the guide bracket 600 illustrated in FIG. 8, the arrangement of the guide bracket 600 may be different. The guide bracket 600 may be provided as a pair of guide brackets 600 in the first direction, and the guide surfaces 610 thereof may be arranged in parallel with each other. The guide surfaces 610 of the pair of guide brackets 600 illustrated in FIG. 15 may be arranged in parallel with each other toward the other side of the first direction.

That is, the guide surface 610 of the guide bracket 600 illustrated in FIG. 8 may be disposed to face the one side of the first direction, and the guide surface 610 of the guide bracket 600 illustrated in FIG. 15 may be disposed to face the other side of the first direction.

A state in which the pair of guide brackets 600 illustrated in FIG. 15 are arranged parallel to each other in the first direction is common to the guide bracket 600 illustrated in FIG. 8, but the lifting part 300 illustrated in FIG. 15 may be lowered as the slider frame 510 is moved toward the other side of the first direction. The descriptions mentioned in FIG. 8 are cited for configurations not separately mentioned in FIG. 15.

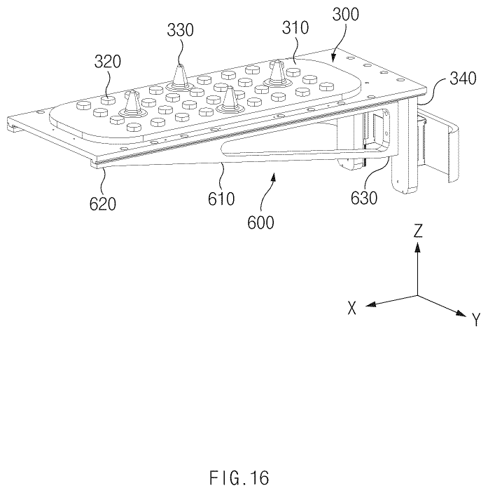

FIG. 16 is a perspective view of a lifting part and a guide bracket according to still another embodiment of the present disclosure.

Referring to FIG. 16, unlike a structure of FIG. 4 in which the pair of guide brackets 600 are coupled in the first direction in both areas of the lifting plate 310 in the third direction, the one guide bracket 600 may be coupled in the first direction in both areas of the lifting plate 310 in the third direction. That is, the pair of guide brackets 600 may be coupled to the lifting plate 310 illustrated in FIG. 16.

The guide bracket 600 illustrated in FIG. 16 may include the guide surface 610 having a gentler inclination than that of the guide surface 610 of the guide bracket 600 illustrated in FIG. 8. According to the structure, one slider roller 520 (see FIG. 8) may be provided in the first direction instead of two slider rollers 520. That is, the slider rollers 520 may be provided in a number corresponding to the number of guide brackets 600.

According to the structure of FIG. 16, a height difference according to the operating range of the lifting part 300 may be smaller than a height difference according to the operating range of the lifting part 300 illustrated in FIG. 8. The descriptions mentioned in FIG. 8 are cited for configurations not separately mentioned in FIG. 16.

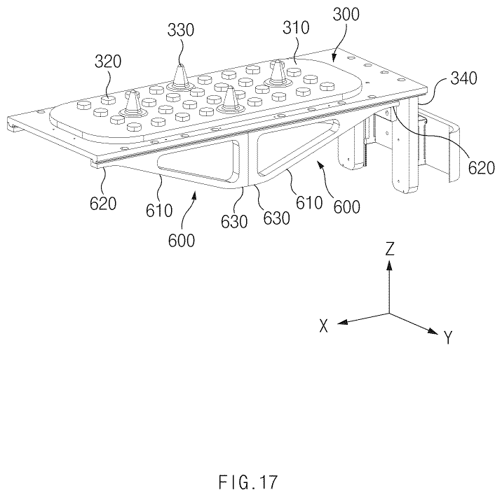

FIG. 17 is a perspective view of a lifting part and a guide bracket according to still another embodiment of the present disclosure.

Referring to FIG. 17, unlike FIG. 4 in which the pair of guide brackets 600 are arranged in parallel with each other in the first direction, the pair of guide brackets 600 may be arranged to face each other in the first direction. That is, the pair of guide brackets 600 are provided in the first direction, and the guide surfaces 610 thereof may be arranged to face each other.

The first seating surface 620 of each of the pair of guide brackets 600 arranged to face each other in the first direction may be formed at a higher position than that of the second seating surface 630.

The second seating surface 630 of the guide bracket 600 disposed on the one side of the first direction among the pair of guide brackets 600 arranged to face each other in the first direction and the second seating surface 630 of the guide bracket 600 disposed on the other side of the first direction among the pair of guide brackets 600 arranged to face each other in the first direction may be in contact with each other.

According to the structure, the one slider roller 520 (see FIG. 8) may be provided in the first direction instead of the two slider rollers 520. In this case, the slider roller 520 may roll along the first seating surface 620, the guide surface 610, and the second seating surface 630 of the guide bracket 600 disposed on the one side of the first direction among the pair of guide brackets 600 arranged to face each other in the first direction, and thus the lifting part 300 may be lifted.

Thereafter, even when a sliding direction of the slider frame 510 is not changed, the slider roller 520 may roll along the second seating surface 630, the guide surface 610, and the first seating surface 620 of the guide bracket 600 disposed on the other side of the first direction among the pair of guide brackets 600 arranged to face each other in the first direction, and thus the lifting part 300 may be lowered.

Thus, as the slider frame 510 slides to the other side of the first direction, the lifting part 300 according to FIG. 17 may be lifted and then lowered. In other words, the lifting part 300 illustrated in FIG. 17 may be sophisticatedly elevated as compared to the elevation of the lifting part 300 illustrated in FIG. 8. The descriptions mentioned in FIG. 8 are cited for configurations not separately mentioned in FIG. 17.

According to the present disclosure, because a lifting part is elevated as a guide bracket interferes with by a slider, an object may be elevated to a desired height.

Further, according to the present disclosure, when the lifting part is disposed at a first position that is a lowest position and a third position that is a highest position, it is not necessary to apply a separate driving force to fix a height of the lifting part, and thus a consumption speed of a driving source may be slowed down.

Further, according to the present disclosure, positions of a driving part, a guide rail, and the like inside a housing may be guided, and thus manufacturability of a lifting apparatus may be improved.

In addition, various effects directly or indirectly identified though the present document may be provided.

The above description is merely illustrative of the technical spirit of the present disclosure, and those skilled in the art to which the present disclosure belongs may make various modifications and changes without departing from the essential features of the present disclosure.

Thus, the embodiments disclosed in the present disclosure are not intended to limit the technology spirit of the present disclosure but are intended to describe the present disclosure, and the scope of the technical spirit of the present disclosure is not limited by these embodiments. The scope of protection of the present disclosure should be interpreted by the appended claims, and all technical spirits within the scope equivalent thereto should be interpreted as being included in the scope of the present disclosure.

1. A lifting apparatus comprising:
a slider configured to slide in a first direction;
a lifting part elevated in a second direction intersecting the first direction by the slider; and
a guide bracket coupled to the lifting part on one side of the lifting part toward the slider and interfering with the slider to elevate the lifting part in the second direction.

2. The lifting apparatus of claim 1, wherein the guide bracket includes a guide surface extending in a direction intersecting the first direction and the second direction on a plane formed parallel to the first direction and the second direction.

3. The lifting apparatus of claim 2, wherein the guide bracket includes:
a first seating surface provided on one side of the guide surface in the first direction and extending parallel in the second direction; and
a second seating surface provided on the other side of the guide surface in the first direction and extending parallel in the second direction.

4. The lifting apparatus of claim 2, wherein the slider includes:
a slider frame configured to slide in the first direction; and
a slider roller rotatably mounted on the slider frame and formed to roll along the guide surface.

5. The lifting apparatus of claim 4, further comprising:
a housing including a base plate and configured to surround the slider and the guide bracket; and
a guide rail supported by the base plate and extending in the first direction to guide sliding of the slider frame.

6. The lifting apparatus of claim 5, wherein the slider further includes a sliding guider fixed to the slider frame and having a guide protrusion protruding toward the guide rail, and
wherein the guide rail includes a rail groove into which the guide protrusion is inserted.

7. The lifting apparatus of claim 4, further comprising:
a driving part configured to slide the slider and including a driving motor and a guide shaft rotated by the driving motor,
wherein the slider further includes a slider coupling part connected to the slider frame and sliding in the first direction by the rotation of the guide shaft.

8. The lifting apparatus of claim 7, wherein the guide shaft is formed as a ball screw, and
wherein the slider coupling part includes a ball nut engaged with the guide shaft.

9. The lifting apparatus of claim 1, wherein the lifting part includes:
a lifting plate to which the guide bracket is coupled and which faces one side of the second direction; and
a lifting column extending from the lifting plate in the second direction to support the lifting plate.

10. The lifting apparatus of claim 9, wherein the lifting part further includes a guide supporter inserted into the lifting column and extending in the second direction, and
wherein the lifting column includes a lifting groove into which the guide supporter is inserted and which extends in the second direction.

11. The lifting apparatus of claim 9, wherein the lifting part further includes a seating pad protruding to the one side of the lifting plate in the second direction and made of an elastic material.

12. The lifting apparatus of claim 9, wherein the lifting plate includes:
a plate area extending in the first direction and a third direction intersecting the first direction and the second direction; and
a protrusion area protruding from the plate area toward the guide bracket and extending in the first direction, and
wherein the guide bracket includes:
a seating wall on which the protrusion area is seated; and
a support wall configured to form a seating groove into which the protrusion area is inserted together with the seating wall and support the protrusion area.

13. The lifting apparatus of claim 9, wherein the guide bracket is provided as a pair of guide brackets in the first direction, and the guide surfaces thereof are i) arranged parallel to each other or ii) arranged to face each other.

14. The lifting apparatus of claim 5, wherein the base plate includes a guide rail groove on which the guide rail is seated.

15. The lifting apparatus of claim 7, further comprising:
a housing including a base plate and configured to surround the slider and the guide bracket,
wherein the driving part includes a shaft support body configured to support the guide shaft, and
wherein the base plate includes a driving motor groove on which the driving motor is seated and a shaft support body groove on which the shaft support body is seated.

16. A lifting apparatus comprising:
a slider configured to slide in a first direction;
a lifting part elevated in a second direction intersecting the first direction by the slider; and
a guide bracket coupled to the lifting part on one side of the lifting part toward the slider and interfering with the slider to elevate the lifting part in the second direction,
wherein the guide bracket includes a surface intersecting the first direction and the second direction on a plane formed parallel to the first direction and the second direction.
